(19) United States
(12) Patent Application Publication
(10) Pub. No.: US 2023/0396097 A1
(43) Pub. Date: Dec. 7, 2023

(54) WIRELESS CHARGING OF ELECTRONIC DEVICES

(71) Applicant: APPLE INC., CUPERTINO, CA (US)

(72) Inventors: Christopher R. Costello, Austin, TX (US); Alexandre R. Moha, Los Altos, CA (US); Cheng Ran Zhang, Sunnyvale, CA (US); Chensong He, Saratoga, CA (US); John T. Perry, Potland, OR (US); Kejia Zhang, San Jose, CA (US); Ankan De, San Jose, CA (US); Di Zhao, Santa Clara, CA (US); Garren T. Lowrance, Waukesha, WI (US); Jizhen Fu, San Jose, CA (US); Aram S. Almuhana, Volente, TX (US); Marc Guinez, Cupertino, CA (US); Samuel B. Schaevitz, Los Gatos, CA (US)

(73) Assignee: APPLE INC., CUPERTINO, CA (US)

(21) Appl. No.: 18/196,911

(22) Filed: May 12, 2023

Related U.S. Application Data
(60) Provisional application No. 63/408,727, filed on Sep. 21, 2022.
(60) Provisional application No. 63/365,853, filed on Jun. 3, 2022.

(51) Int. Cl. H02J 50/10; H02J 7/00; H02J 50/80; H02J 50/40; H02J 50/00; H04B 5/00

(52) U.S. Cl. CPC H02J 50/10; H02J 7/0044; H02J 50/80; H02J 7/00712; H02J 7/007192; H02J 50/402; H02J 50/005; H04B 5/0037

(57) ABSTRACT

A wireless power transmitting device includes a surface adapted to support a container containing a wireless power receiving device and further includes a wireless power transfer coil positioned to couple with a wireless power receiving coil of the wireless power receiving device when the container is placed on the surface. The wireless power transmitting device detects a presence of the wireless power receiving device when the container containing the wireless power receiving device is placed on the surface and determines whether the wireless power receiving device permits wireless power transfer while it is inside the container. Using the wireless power transfer coil, the wireless power transmitting device wirelessly transmits power to the wireless power receiving device through the container to charge a battery of the wireless power receiving device, in accordance with determining the wireless power receiving device permits wireless power transfer while it is inside the container.

### CROSS-REFERENCES TO OTHER APPLICATIONS

This application claims priority to U.S. provisional patent application Ser. No. 63/365,853, for “IN-BOX SOFTWARE UPDATES” filed on Jun. 3, 2022 and to U.S. provisional patent application Ser. No. 63/408,727, for “WIRELESS CHARGING OF ELECTRONIC DEVICE” filed on Sep. 21, 2022 which are each hereby incorporated by reference in entirety for all purposes.

### FIELD

The present disclosure relates generally to techniques for charging an electronic device wirelessly.

### BACKGROUND

During manufacturing of portable electronic devices such as a cellular phone, a battery within the portable electronic device is charged and the portable electronic device is loaded with software available at the time of manufacture. The portable electronic device may then be placed in a low-power mode (e.g., shelf-life mode, sleep mode, etc.) to conserve power while it is packaged within a retail container. Some time may pass between the time of manufacture and the time of purchase of the device. Meanwhile, the battery may discharge and newer software may become available.

### SUMMARY

Customer experience is improved by re-charging and updating mobile devices to available software, as appropriate, before sale, so that the customer can enjoy the features of the device quickly after purchase. Accordingly, apparatuses and techniques for waking mobile devices from a low-power mode, charging the mobile devices and updating their software after manufacturing while the devices remain boxed is desirable. It is noted that some mobile devices are packaged in sealed containers and thus can further benefit from wireless charging and wireless software updates.

In some embodiments a wireless power transmitting device comprises a surface adapted to support a container containing a wireless power receiving device and a wireless power transfer coil positioned to couple with a wireless power receiving coil of the wireless power receiving device when the container is placed on the surface. A memory comprises computer-executable instructions, and one or more processors are in communication with the memory and are configured to access the memory and execute the computer-executable instructions to perform operations comprising: detecting a presence of the wireless power receiving device when the container containing the wireless power receiving device is placed on the surface; determining whether the wireless power receiving device permits wireless power transfer while it is inside the container; and using the wireless power transfer coil, wirelessly transmit power to the wireless power receiving device through the container to charge a battery of the wireless power receiving device, in accordance with determining the wireless power receiving device permits wireless power transfer while it is inside the container.

In some embodiments determining whether the wireless power receiving device permits wireless power transfer while it is inside the container comprises: communicating with the wireless power receiving device using modulation of a wireless power transfer signal at the wireless power transfer coil. In various embodiments determining whether the wireless power receiving device permits wireless power transfer while it is inside the container comprises: communicating with the wireless power receiving device using a wireless communication protocol and circuitry other than the wireless power transfer coil.

In some embodiments the wireless communication protocol and circuitry are near-field communications (NFC). In various embodiments the wireless communication protocol and circuitry are Bluetooth, WiFi, or RFID. In some embodiments the operations further comprise, in response to determining that the battery of the wireless power receiving device has been charged to a threshold level, transmitting instructions to the wireless power receiving device to update an operating system. In various embodiments transmitting instructions to the wireless power receiving device to update an operating system comprises determining an existing version of operating system installed on the wireless power receiving device and determining that a version of the operating system newer than the existing version is available.

In some embodiments the operations further comprise, in response to determining that the wireless power receiving device has been registered with a user account or registered with a SIM credential (either physical or e-SIM), determining that the wireless power receiving device has been removed from the container. In various embodiments the operations further comprise determining whether a temperature of the wireless power receiving device exceeds an inbox charging threshold and discontinuing the transmitting the power signal responsive to determining the temperature exceeds the inbox charging threshold.

In some embodiments the wireless power transmitting device further comprises a plurality of wireless power transfer coils and wherein detecting a presence of the wireless power receiving device when the container containing the wireless power receiving device is placed on the surface comprises detecting coupling between a particular wireless power transfer coil of the plurality of wireless power transfer coils of the wireless power transmitting device with the wireless power receiving coil of the wireless power receiving device, selecting the particular wireless power transfer coil of the plurality of wireless power transfer coils and using the selected wireless power transmit coil to wirelessly transmit power to the wireless power receiving device.

In some embodiments the wireless power transmitting device further comprises a ferrite material abutting the wireless power transfer coil and wherein the ferrite material is shaped to optimize transmission of flux generated by the wireless power transfer coil, through a wall of the container, towards the wireless power receiving coil of the wireless power receiving device.

In some embodiments a portable electronic device comprises a memory comprising computer-executable instructions and one or more processors in communication with the memory and configured to access the memory and execute the computer-executable instructions to perform operations comprising: detecting a wireless communication signal, in response to detecting the wireless communication signal, determining whether the portable electronic device is enclosed within a container and in response to determining that the portable electronic device is enclosed within the container, wirelessly receiving power to charge a battery of the portable electronic device.

In some embodiments the operations further comprise wirelessly receiving data through the container and in response to receiving the data, updating an operating system of the portable electronic device. In various embodiments the wireless communication signal is received by a first antenna and wherein the data is received by a second antenna. In some embodiments the container comprises a non-electrically conductive wall and wherein the portable electronic device is positioned adjacent the non-electrically conductive wall. In various embodiments the operations further comprise, in response to detecting the wireless communication signal, determining whether the portable electronic device is unregistered with a user account or is not registered with SIM, and in response to determining that the electronic device is unregistered or is not registered with a SIM, establish communications with a wireless power transmitter via a wireless power receiving coil.

In some embodiments the operations further comprise, in response to detecting the wireless communication signal, transitioning from a power save mode to an active mode. In various embodiments the operations further comprise, in response to detecting the wireless communication signal, determining whether the wireless communication signal is from a charger configured to perform in-box charging of the portable electronic device, and in response to determining that the wireless communication signal is from a charger configured to perform in-box charging of the portable electronic device, wirelessly receiving the power to charge the battery of the portable electronic device.

In some embodiments the operations further comprise, in response to detecting the wireless communication signal, turning on at least one of an NFC, Bluetooth, WiFi or RFID communications circuit, in accordance with determining that the wireless communication signal is from a charger configured to perform in-box charging of the portable electronic device. In various embodiments the operations further comprise, communicating with the charger to transmit at least one of a battery state-of-charge, an operating system version or a thermal status, in accordance with determining that the wireless communication signal is from a charger configured to perform in-box charging of the portable electronic device.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 depicts a simplified isometric top view of a portable electronic device enclosed within a container, according to embodiments of the disclosure;

FIG. 2 depicts a simplified isometric top view of a charging station that can be used to charge portable electronic device shown in FIG. 1, according to embodiments of the disclosure;

FIG. 3 depicts a simplified cross-sectional view of a portable electronic device enclosed in container that is positioned on charging surface of charging station, according to embodiments of the disclosure;

FIG. 4 illustrates a simplified system for charging portable electronic device enclosed by container, according to embodiments of the disclosure;

FIG. 5 illustrates steps associated with a method for charging a portable electronic device enclosed by a container, according to embodiments of the disclosure;

FIG. 6 illustrates a simplified top view of a charging station with multiple wireless power transfer coils, according to embodiments of the disclosure;

FIG. 7 is a block diagram of an example portable electronic device according to embodiments of the disclosure; and

FIG. 8 is a block diagram of an example charging station according to embodiments of the disclosure.

### DETAILED DESCRIPTION

Embodiments of the present disclosure relate to techniques for waking a portable electronic device from a low-power mode, charging a battery of the portable electronic device and updating software on the device while it is enclosed within a container such as its retail box. During manufacture of the portable electronic device, the portable electronic device may be placed into a low-power mode (e.g., shelf-life, sleep mode, etc.) that disables certain device features to conserve battery power. While in the low-power mode, the portable electronic device may selectively respond to inputs, such as to respond to a particular type of wireless transmission that is sent by a charging station that is configured to communicate with the portable electronic device while it is enclosed in the container, while foregoing responses to other types of inputs.

For example, to interrupt the low-power mode the portable electronic device can be woken up, while in the container, using a charging station that is configured to charge the portable electronic device through the container. In addition, the charging station can communicate with the portable electronic device via an in-band communication protocol through the coupled wireless charging coils, via a peer-to-peer wireless protocol, e.g., near-field communication (NFC), Wireless Fidelity (WiFi, also known as Wireless Local Area Network), Bluetooth, Radio Frequency Identification (RFID) or other suitable communications system. In some examples, a portable electronic device that is in low-power mode awakes to inductive charging signals, and responsive to awakening due to the inductive charging signals, communicates through additional wireless protocols. In some examples, a portable electronic device that is in low-power mode awakes to certain wireless communications, and responsive to awakening due to wireless communications, enables its wireless charging circuitry.

Wireless charging between the portable electronic device within the container and the charging station can occur using a charging standard such as Qi, which is published by the Wireless Power Consortium standards organization, or other suitable wireless charging protocol. Charging can continue until the battery of the portable electronic device reaches a threshold state of charge level (e.g., 80%). The portable electronic device can communicate battery state of charge information to the charging station, or can otherwise request charging to cease when a sufficient state of charge is obtained. Charging can continue while the portable electronic device within the container remains below a threshold temperature level. The charging station can temporarily halt the charging operation if the temperature of the portable electronic device exceeds the threshold temperature. The portable electronic device can communicate temperature information to the charging station, or can otherwise request charging to cease when its temperature exceeds a threshold. The portable electronic device can be authorized to update its software via a wireless communication connection (e.g., WiFi). The portable electronic device can communicate information such as its device type and current software version information to the charging station or other content provider. In some implementations this occurs when the device is sufficiently charged to a threshold level (e.g., 50%).

When the portable electronic device has completed charging and/or updating software, the portable electronic device can return to the low-power mode. The portable electronic device can communicate this status to the charging station such that the status can be presented to an operator of the charging station, even if the portable electronic device remains enclosed within the container.

In order to better appreciate the features and aspects of portable electronic devices that can be charged and updated while enclosed in a container according to the present disclosure, further context for the disclosure is provided in the following section by discussing one particular implementation of a portable electronic device according to embodiments of the present disclosure. These embodiments are for example only and other embodiments can be employed in other battery-powered electronic devices such as, but not limited to computers, tablet computing devices, watches, media players and other electronic devices.

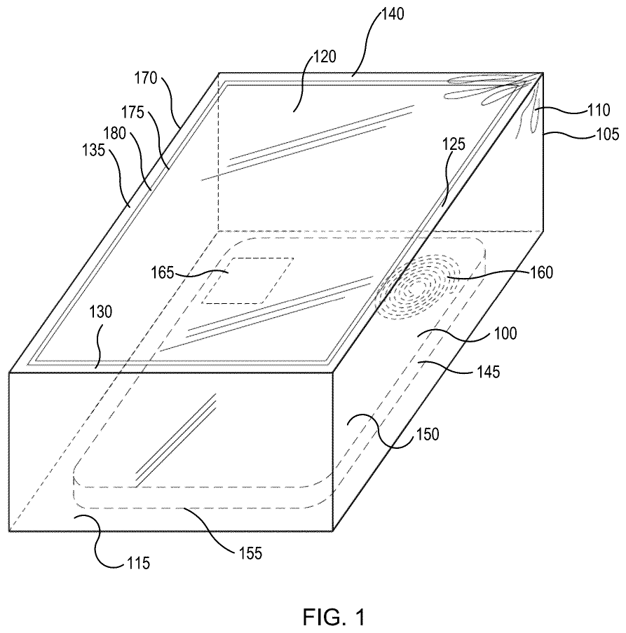

FIG. 1 depicts a simplified isometric top view of a portable electronic device 100 enclosed within a container 105, according to some embodiments of the disclosure. As shown in FIG. 1, container 105 may be a retail packaging enclosure and may include an optional exterior seal 110. In some embodiments, container 105 can include a first shell 170 that is sized and arranged to receive a second shell 175, with a gap 180 defined therebetween. First shell 170 may include five walls including a first wall 115 with first, second, third and fourth side walls, 125, 130, 135, 140, respectively, extending therefrom and defining a first cavity sized and shaped to receive second shell 175 via a first opening. Second shell 175 may also have five walls including a second wall 120 that is positioned opposite first wall 115 (when the second shell is received by the first shell). Four side walls of second shell 175 (not shown in FIG. 1) extend from second wall 120 and may define a second cavity sized and shaped to receive portable electronic device 100 via a second opening. When second shell 175 is received by first shell 170 (as shown in FIG. 1) they may fit together to form container 105 that fully encloses portable electronic device 100.

Other embodiments may include containers of different geometries and/or configurations which are within the scope of this disclosure. Container 105 can be constructed of any suitable material including paper-based material (cardboard), plastic or other suitable non-electrically conductive material. At least one wall, such as exemplary first wall 115 is constructed of a non-electrically conductive and non-magnetic material while the other portions of container 105 can be constructed of other suitable types of material.

Portable electronic device 100 can be a smart phone, tablet computer, portable media player, watch or other type of battery-powered electronic device. Portable electronic device 100 includes top surface 150 opposite a back surface 155 that contribute to forming an exterior enclosure 145. A wireless power receiving coil 160 for receiving power from a wireless charger (not shown in FIG. 1) can be positioned within housing 145 and located proximate back surface 155. In some embodiments wireless power receiving coil 160 can be centered in-plane with the first wall 115 such that the coil is positioned proximate the center of one or both of the X and Y axis of the first wall. A display screen (not shown) can be positioned proximate top surface 150. Portable electronic device 100 may also include one or more wireless communication antennas 165 (e.g., NFC, Bluetooth, WiFi, RFID, etc.), one or more processors and a rechargeable battery.

In some embodiments an exterior surface of first wall 115 may be a “top” surface of container 105 and may include graphics, impressions, etc. that are first presented to a user and may be recognized by the user as a “top” of the container. Portable electronic device 100 may be oriented within container 105 with back surface 155 adjacent first wall 115 such that when first shell 170 is removed from second shell 175, the back surface of the portable electronic device 100 is first presented to the user. Not only does this orientation of portable electronic device 100 within container 105 enable the first presentation of back surface 155 to a user upon opening the container, it enables wireless power receiving coil 160 to be positioned proximate first wall 115 to enable wireless charging of the portable electronic device through the first wall, as explained in more detail below.

While enclosed by container 105, portable electronic device 100 can remain in a sleep mode (e.g., low-power mode) to conserve power and may be configured to respond only to a particular wireless signal from a charging station that is configured to communicate with the portable electronic device while it is enclosed in the container. Responsive to receiving the particular wireless signal, the portable electronic device can wake from the sleep mode and can receive wireless power and/or perform wireless communications, as described in more detail herein.

In some embodiments, seal 110 may be an exterior layer of polymer-based material (e.g., plastic shrink wrap) that fully encloses container 105. In various embodiments seal 110 may be an exterior layer of polymer-based material that partially encloses or secures container 105 in a closed position and may optionally include one or more pull tabs that can be used to release a portion of the seal to enable the container to be opened. The material is, for example, a layer of polymer-based or paper-based material. The one or more pull tabs can release a portion of the material that is holding container 105 in the closed position. In some embodiments seal 110 may be a layer of tamper-resistant tape, glue or other suitable structure that prevents or indicates tampering with container 105 and/or portable electronic device 100.

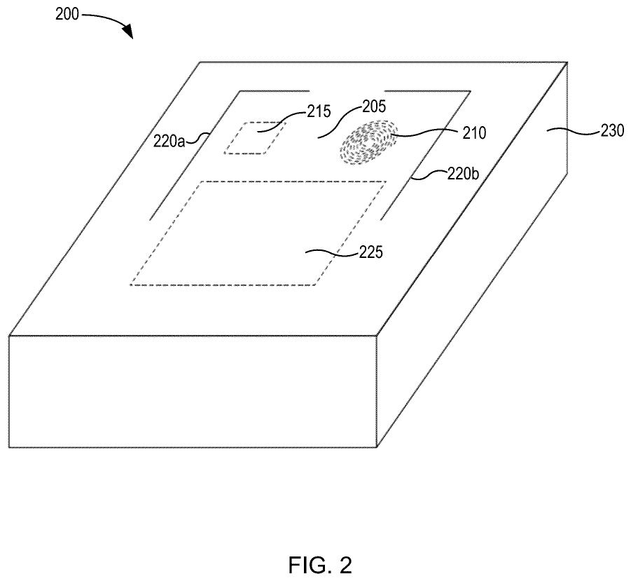

FIG. 2 depicts a simplified isometric top view of a charging station 200 that can be used to charge portable electronic device 100 shown in FIG. 1, according to embodiments of the disclosure. As shown in FIG. 2, charging station 200 includes a charging surface 205 adapted to support container 105 (see FIG. 1) that encloses portable electronic device 100. Charging station 200 also includes a wireless power transfer coil 210 positioned to couple with wireless power receiving coil 160 (see FIG. 1) of portable electronic device 100 when container 105 is placed on charging surface 205. In some embodiments, wireless power transfer coil 210 and wireless power receiving coil 160 (see FIG. 1) of portable electronic device 100 may form an inductive couple through which in-band bi-directional communications may be performed via modulation of a wireless power transfer signal at the wireless power transfer coil. Charging station 200 may also include one or more antennas 215 to perform communications with portable electronic device using a wireless communication protocol and circuitry other than via the wireless power transfer coils (e.g., NFC, Bluetooth, WiFi, RFID, etc.).

Charging station 200 may also include one or more alignment aids 220a and 220b at charging surface 205 that facilitate optical and/or mechanical alignment of container 105 (see FIG. 1) on the charging surface such that wireless power transfer coil 210 is aligned with wireless power receiving coil 160 (see FIG. 1). Alignment aids 220a and 220b may be adjustable to accommodate different models of portable electronic devices that may have a wireless receiving coil in a different location, a different physical geometry and/or are enclosed in a container having a different geometry. More specifically, alignment aids 220a and 220b may be used to assist alignment of wireless power transfer coil 210 with wireless power receiving coil 160 (see FIG. 1) across varying portable electronic device models and container geometries. In some embodiments alignment aids 220a and 220b may include or may be assisted by one or more magnets within charging station 200 that are arranged to attract corresponding magnets and/or magnetic materials within portable electronic device 100 and/or within container 105. Charging station 200 may also include more than one wireless power transfer coils 210 and/or power transfer coils at different orientations, as explained in more detail below. In some embodiments charging station 200 can also include an integrated cooling plate 225 that can be thermally coupled to portable electronic device 100 (see FIG. 1) through container 105 to control a temperature of the portable electronic device during charging.

In some embodiments charging station 200 is operatively coupled with circuitry that detects whether a portable electronic device 100 is present inside a container 105 that is placed on charging surface 205. In some examples the circuitry is integrated with charging station 200 as part enclosure 230. In various examples the circuitry resides with a coupled host computing device.

Detection of portable electronic device 100 can be performed via wireless power transfer coil 210, via one or more sensors or other suitable techniques such as, for example, an operator informing the charging station that a container is in place. Charging station 200 may be configured to transmit a particular wireless signal from wireless power transfer coil 210 to wireless power receiving coil 160 (see FIG. 1) of portable electronic device 100 while the portable electronic device is enclosed in container 105. More specifically, in some embodiments the particular wireless signal may be different from the wireless signals that the portable electronic device would be exposed to in a typical, post-sale, operating environment, while in other embodiments the particular wireless signal may be the same or a similar wireless signal that the portable electronic device would be exposed to. For example, a wireless charging signal may be used that has a unique operating frequency and/or includes unique modulated data, etc., while in other embodiments a standard Qi compliant charging signal may be used to wake the portable electronic device.

In response to receiving the particular wireless signal portable electronic device 100 (see FIG. 1) is woken out of the sleep mode and may perform a self-diagnostic process to determine one or more of a level of charge of its battery, a temperature of the portable electronic device, a version of its operating system and whether the portable electronic device is within container 105. For example, in some embodiments portable electronic device 100 (see FIG. 1) can indirectly determine whether it remains in a pre-sale condition, and thus likely to be in a container, by determining one or more of the following parameters: it is unregistered, it has no user information installed, it does not have a SIM card installed (or e-SIM is not registered), the physical control devices of the portable electronic device have not been activated since it was placed in the sleep mode, etc.

In some embodiments the physical control devices include, but are not limited to pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. Physical control devices may also include a touch screen, or a touchpad for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

The portable electronic device can transmit information to charging station 200 indicating one or more of its current operating parameters. Based on the information received from the charging station, and its self-diagnostic, the portable electronic device can determine whether it would accept wireless power transfer and/or software updates.

In response to receiving the transmitted information from portable electronic device 100 (see FIG. 1), charging station 200 may determine that the portable electronic device permits wireless power transfer while it is inside the container. For example, charging station 200 may verify a device identification of the portable electronic device, that the portable electronic device is authorized, etc. Upon determining that portable electronic device 100 (see FIG. 1) permits wireless power transfer while inside container 105 and/or other suitable parameters (e.g., that the temperature of the portable electronic device is below a threshold temperature) charging station 200 can wirelessly transmit power to the portable electronic device through the container to charge a battery of the portable electronic device. Charging station 200 illustrated in FIG. 2 shows only one charging surface 205, however other embodiments may have any suitable number of charging surfaces including more than 2, between 2 and 20 charging surfaces, between 4 and 10 charging surfaces and between 5 and 7 charging surfaces.

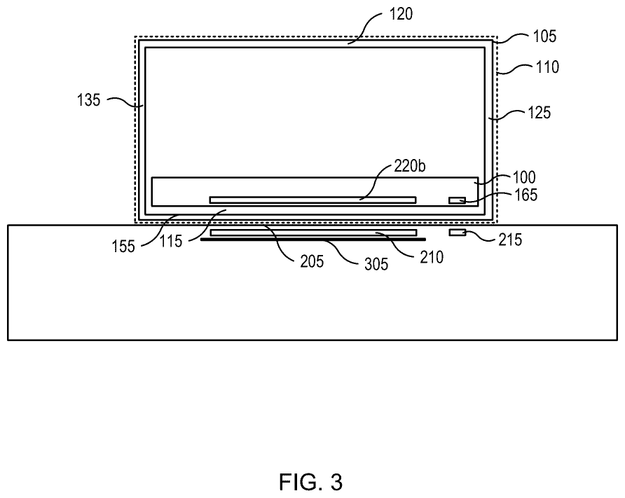

FIG. 3 depicts a simplified cross-sectional view of portable electronic device 100 enclosed in container 105 that is positioned on charging surface 205 of charging station 200. As shown in FIG. 3, first wall 115 of container 105 is positioned adjacent charging surface 205. Wireless power receiving coil 160 is located proximate back surface 155 of portable electronic device 100 so a distance between wireless power receiving coil 160 and wireless power transfer coil 210 can be minimized. Container 105 is surrounded by an optional exterior tamper-resistant seal 110 (e.g., plastic shrink wrap). First wall 115 and tamper-resistant seal 110 are non-electrically conductive and non-magnetic such that wireless power transfer coil 210 can wirelessly transfer power through first wall 115 and through tamper-resistant seal 110 to wireless power receiving coil 160.

In some embodiments a distance between wireless power receiving coil 160 and wireless power transfer coil 210 is 2 millimeters (mm), 3 mm, 4 mm, 5 mm, 10 mm, 20 mm, 30 mm, 40 mm, 50 mm, etc. Due to the presence of container 105, these distances may be larger than gap distances typically experienced by electronic device 100 during normal wireless charging by consumers. Charging station 200 may be designed to support charging over greater than typical distances. In one embodiment charging station 200 includes one or more ferrite and/or shielding layers 305 that are shaped to optimize transmission of flux generated by the wireless power transfer coil, through first wall 115 of container 105, towards power receiving coil 160 of portable electronic device 100. Thus, charging station 200 may be designed to optimize efficiency of the wireless power transfer over a larger than normal separation between the coils.

As further shown in FIG. 3, antenna 215 of charging station 200 may align positionally with a corresponding communication antenna 165 in portable electronic device 100 to form a wireless communication system that operates using wireless protocols, such as NFC, Bluetooth, WiFi, RFID, etc.

In some embodiments a thickness of first wall 115 may be between 0.1 mm and 3 mm, between 0.5 mm and 2 mm or between 0.75 mm and 1.5 mm.

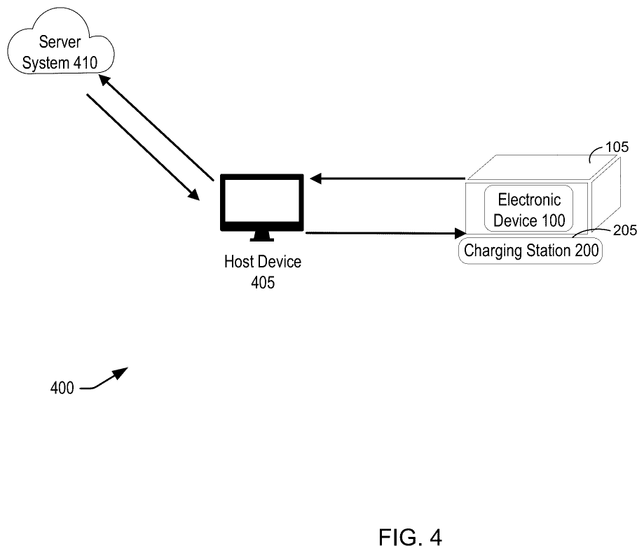

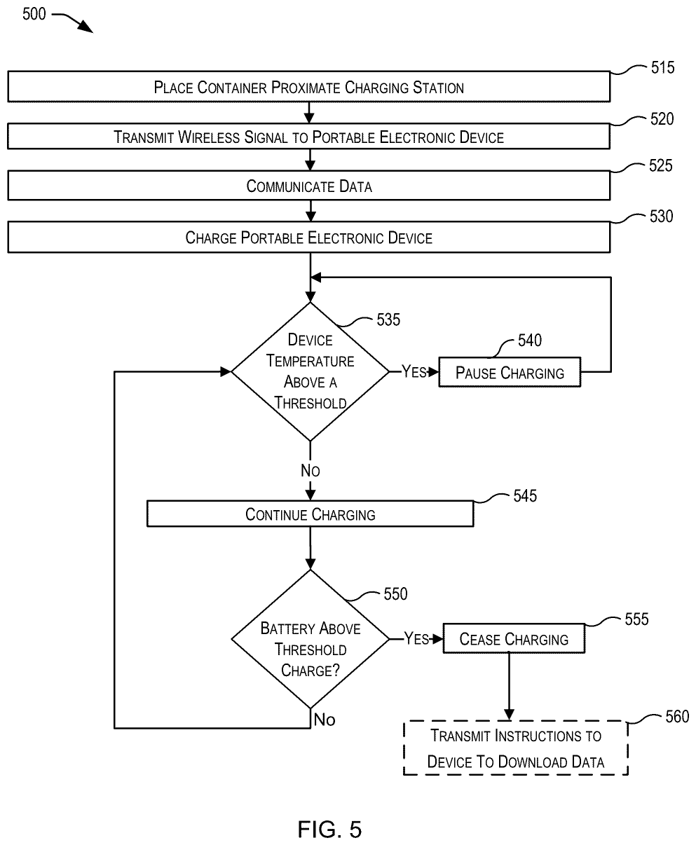

FIG. 4 illustrates a simplified system 400 for charging portable electronic device 100 enclosed by container 105, according to embodiments of the disclosure. FIG. 5 illustrates steps associated with a method 500 for charging the portable electronic device enclosed by a container using system 400 shown in FIG. 4.

System 400 includes one or more electronic devices (e.g., portable electronic device 100, charging station 200, host device 405, system server/cloud 410) and can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by one or more components of system 400, cause the system to perform the actions.

In block 515 of method 500, container 105 that contains portable electronic device 100 is positioned proximate charging station 200. In some embodiments container 105 is oriented “upside-down” with a “top” surface of the container positioned against charging surface 205 of the charging device.

In some embodiments container 105 is made from a non-electrically conductive and non-magnetic material and facilitates retail sale of portable electronic device 100. When portable electronic device 100 is positioned within container 105 (e.g., during the manufacturing process) it may be placed in a sleep mode (e.g., low-power mode) to preserve battery life and may only respond to particular wireless signals from charging station 200 or from interaction by a user to turn on the portable electronic device.

In some embodiments an optional seal (not shown in FIG. 4) is formed on or around container 105. In various embodiments, the seal may be an exterior layer of polymer-based material (e.g., plastic shrink wrap) that fully encloses container 105. In some embodiments the seal may be an exterior layer of polymer-based material that partially encloses or secures container 105 and may optionally include one or more pull tabs that can be used to release a glued or heat-staked portion of the seal to enable access to container. In various embodiments the seal may be a layer of tamper-resistant tape, glue or other suitable structure that prevents or indicates tampering with container 105 and/or portable electronic device 100.

In block 520 of method 500, charging station 200 transmits a particular wireless signal to portable electronic device 100. The portable electronic device 100 is configured to receive the particular wireless signal while it is within container 105 and to respond by, for example, waking one or more processors out of a sleep mode.

In some embodiments the particular wireless signal is transmitted via wireless power transmission coil 210 (see FIGS. 2 and 3) using a wireless charging communications protocol, while in other embodiments the particular wireless signal is transmitted via a communications antenna using a wireless communications protocol other than the wireless charging communications protocol (e.g., NFC, Bluetooth, WiFi, RFID, etc.).

In some embodiments the particular wireless signal transmitted via the wireless power transmission coil is an industry standard signal such as, for example, a Qi compatible communications signal. However, in other embodiments the particular wireless signal transmitted via the wireless power transmission coil is a non-standard signal that uses, for example, a proprietary operating frequency, data modulation scheme, proprietary data or other suitable technique to customize the signal.

In some embodiments the particular wireless signal transmitted from the communications antenna is an industry standard signal such as, for example, an NFC signal compatible with an NFC Forum Standard (e.g., ISO14443, 18092 or FeliCa), a WiFi Standard (such as Institute of Electrical and Electronics Engineers (IEEE) 802.11a, IEEE 802.11b, IEEE 802.11g and/or IEEE 802.11n), a Bluetooth signal compatible with a Bluetooth Standard (e.g., IEEE 802.14.1) or other suitable communications standard. However, in other embodiments the particular wireless signal transmitted via the communications antenna is a non-standard signal that uses, for example, a proprietary operating frequency, data modulation scheme, proprietary data or other suitable technique to customize the signal.

In some embodiments while portable electronic device 100 is enclosed in container 105, the portable electronic device may be configured to only receive one particular wireless signal from the charging station (e.g., to communicate data to a processor of the portable electronic device in response to one or more antennas of the portable electronic device receiving the one particular wireless signal). That is, while in container 105, portable electronic device 100 may be configured to not receive and/or respond to other wireless communication signals that the portable electronic device would typically receive and/or respond to when outside of the container.

In some embodiments while portable electronic device 100 is enclosed in container 105, the portable electronic device may be configured to only receive and/or respond to two, three, four or more particular wireless signals from the charging station. In various embodiments, portable electronic device 100 may be configured to receive and/or respond to one less wireless communications signal than it would receive and/or respond to when outside of the container.

In block 525 of method 500, data can be communicated with portable electronic device 100. In some embodiments the data can be bi-directionally communicated between portable electronic device 100 and charging station 200, while in other embodiments the data can be communicated between the portable electronic device and host device 405 or between the portable electronic device and another device (e.g., WiFi access point). Any suitable wireless communication protocol may be used for communicating the data including but not limited to, in-band wireless communications via wireless power transfer coil 210 (see FIGS. 2 and 3), NFC, Bluetooth, WiFi or RFID.

In some embodiments during data communications charging station 200 receives data from portable electronic device 100 indicating that the portable electronic device is within container 105. For example, in some embodiments portable electronic device 100 can, upon waking from the sleep mode, determine that it is in container 105 by determining one or more of the following parameters: it is unregistered, it has no user information installed, it does not have a SIM card installed (or e-SIM is not registered), the physical control devices of the portable electronic device have not been activated since it was placed in the sleep mode, etc. In some embodiments during communication a device identification is received from portable electronic device 100 and is validated with server/cloud 410 to verify the authenticity of the portable electronic device, the software version or other pertinent information of the portable electronic device. In further embodiments a state of charge of the battery of portable electronic device 100, a temperature level of the portable electronic device a software version of the portable electronic device or other suitable information is received by charging station 200, and/or host 405.

In block 530 of method 500, charging station 200 charges a battery of portable electronic device 100 via wireless power transfer while the portable electronic device is enclosed within container 105. In some embodiments the charging is performed in response to determining that a charge level of the battery of portable electronic device 100 device is below a threshold level. Charging station 200 can be configured to charge a portable electronic device 100 with a distance between the inductive charger and the electronic device of 2 mm, 3 mm, 4 mm, 5 mm, 10 mm, 20 mm, 30 mm, 40 mm, 50 mm, etc.

In block 535 of method 500, a temperature of portable electronic device 100 can be compared to a threshold value. In some embodiments the temperature of portable electronic device 100 is sent to charging station 200 and/or host device 405 while in other embodiments a parameter (e.g., voltage level, etc.) is transmitted that is indicative of a temperature of the portable electronic device. Charging station 200, host device 405 and/or portable electronic device 100 can determine whether the temperature of portable electronic device 100 is above or below the threshold. If the temperature of portable electronic device 100 is above a threshold charging station 200 and/or host device 405 proceed to block 540 where charging is paused. In some embodiments the pause can be for a predetermined time duration while in other embodiments it can be until a temperature of portable electronic device 100 is below a lower threshold temperature. In further embodiments, the charging duty cycle can be predefined to maintain the temperature of portable electronic device 100 below the threshold value without transmitting and comparing the temperature of the portable electronic device.

At the end of the pause, method 500 proceeds back to block 535 where the temperature of portable electronic device 100 is compared to a threshold level. If the temperature of portable electronic device 100 is below the threshold level then method 500 proceeds to block 545 in which the charging process continues. In some embodiments the threshold temperature used in block 535 may be different than a threshold temperature used during normal operation of portable electronic device 100 outside of container 105. For example, when outside of container 105 under normal use conditions by a user, portable electronic device 100 may be able to operate at higher temperatures as it is not enclosed in a container and may be able to dissipate more thermal energy.

In block 550 of method 500, a charge level of the battery of portable electronic device 100 can be compared to a threshold value. In some embodiments the charge level of the battery of portable electronic device 100 is sent to charging station 200 and/or host device 405 while in other embodiments a parameter (e.g., voltage level, etc.) is transmitted that is indicative of a charge level of the battery of the portable electronic device. If charging station 200, host device 405 and/or portable electronic device 100 determines that the charge level of the battery is below the threshold value method 500 proceeds back to block 535 where the device temperature is compared to a threshold value. If charging station 200 and/or host device 405 determines that the charge level of the battery is above the threshold level, method 500 proceeds to block 555 where the charging process is stopped. If at some time during the charging process communications is lost with portable electronic device 100, the method may return to block 520 to restart the entire process.

In block 560 of method 500, a battery of portable electronic device 100 has been charged to a threshold level and charging station 200 and/or host device 405 can optionally transmit instructions to the portable electronic device to download data. In some embodiments portable electronic device 100 can receive permission to search for a wireless network to download data from. For example, the network may be a WiFi network and portable electronic device 100 may be provided a network ID that is a service set identifier (SSID) identifying a particular access point. Access credentials for the network can be obtained by the portable electronic device during manufacturing or during communication with charging station 200 and/or host device 405, such as communications occurring in-band during wireless power transfer. Once a connection is established with the network portable electronic device 100 can be instructed to update an operating system or perform other functions.

It will be appreciated that method 500 is illustrative and that variations and modifications are possible. Some blocks described as sequential may be executed in parallel, order of some blocks may be varied, and blocks may be modified, combined, added or omitted.

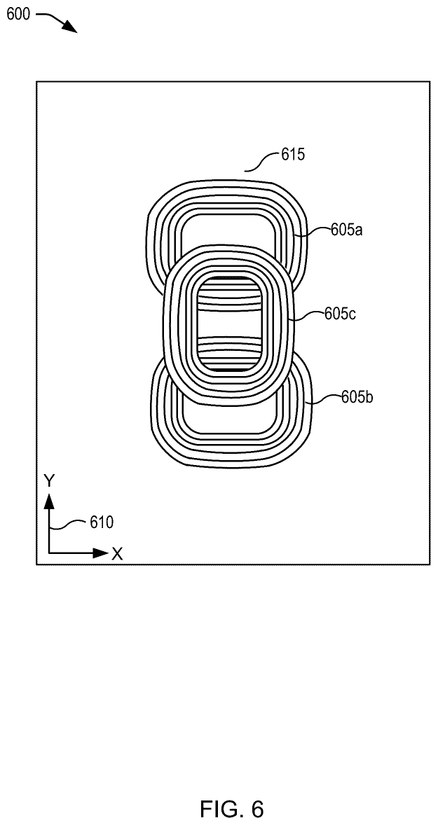

FIG. 6 illustrates a simplified top view of a charging device 600 having multiple coils 605a-605c. In some embodiments, charging device 600 may form part of the charging station 200 discussed above, with reference to FIG. 2. Exemplary charging coils 605a, 605b, 605c can be arranged in a DDQ configuration to facilitate coupling with a wireless receiving device such as portable electronic device 100 (FIG. 1). For example, coil 605c may couple with portable electronic device 100 when a container (e.g., container 105 in FIGS. 1 and 3) containing the portable electronic device is placed adjacent a center of charging surface 615 of charging device 600. Further, coils 605a and 605b are positioned to couple with portable electronic device 100 should the container containing the portable electronic device be offset along Y-axis 610 of charging device 600. In other embodiments, charging device 600 may have less than three or more than three wireless power transfer coils. In some embodiments, charging device 600 has one coil that is centrally located on charging surface 615 of charging station 200.

Having multiple coils positioned adjacent each other (e.g., coils 605a and 605b) enables a greater degree of flexibility with regard to positioning portable electronic device 100 along Y-axis 610 of charging device 600. Thus, charging station 605 may enable portable electronic devices of various geometries and the associated containers of various sizes to align with a power transmission coil. In further embodiments fewer than, or more than three coils can be positioned at charging surface 615 such that portable electronic device 100 can be positioned at desired locations on charging surface and be charged. Any suitable combination of the number of charging coils, the rotation of charging coils and/or the alignment of charging coils can be used in a charging station.

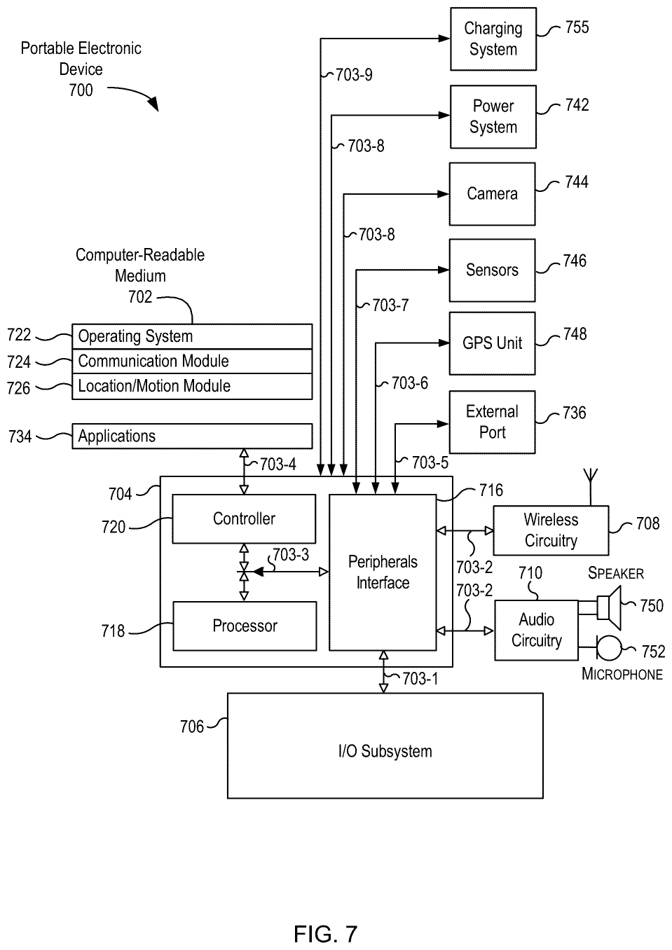

FIG. 7 is a block diagram of an example portable electronic device 700 according to an embodiment. In some embodiments portable electronic device 700 represents portable electronic device 100 as discussed above with reference to FIGS. 1, 3 and 4, and may include a wireless power receiving coil configured to receive power from a charging station (e.g., charging station 200 in FIGS. 2, 3 and 4) while the portable electronic device is enclosed within a container (e.g., container 105 in FIGS. 1, 3 and 4).

Device 700 generally includes computer-readable medium 702, a processing system 704, an Input/Output (I/O) subsystem 706, wireless circuitry 708, and audio circuitry 710 including speaker 712 and microphone 714. These components may be coupled by one or more communication buses or signal lines 703. Device 700 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, a watch or the like, including a combination of two or more of these items.

It should be apparent that the architecture shown in FIG. 7 is only one example of an architecture for device 700, and that device 700 can have more or fewer components than shown, or a different configuration of components. The various components shown in FIG. 7 can be implemented in hardware, software, or a combination of both hardware and software, including one or more signal processing and/or application specific integrated circuits.

Wireless circuitry 708 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 708 can use various protocols, e.g., as described herein. In various embodiments, wireless circuitry 708 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 708 is coupled to processing system 704 via peripherals interface 716. Peripherals interface 716 can include conventional components for establishing and maintaining communication between peripherals and processing system 704. Voice and data information received by wireless circuitry 708 (e.g., in speech recognition or voice command applications) is sent to one or more processors 718 via peripherals interface 716. One or more processors 718 are configurable to process various data formats for one or more application programs 734 stored on medium 702.

Peripherals interface 716 couple the input and output peripherals of device 700 to the one or more processors 718 and computer-readable medium 702. One or more processors 718 communicate with computer-readable medium 702 via a controller 720. Computer-readable medium 702 can be any device or medium that can store code and/or data for use by one or more processors 718. Computer-readable medium 702 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 716, one or more processors 718, and controller 720 can be implemented on a single chip, such as processing system 704. In some other embodiments, they can be implemented on separate chips.

Processor(s) 718 can include hardware and/or software elements that perform one or more processing functions, such as mathematical operations, logical operations, data manipulation operations, data transfer operations, controlling the reception of user input, controlling output of information to users, or the like. Processor(s) 718 can be embodied as one or more hardware processors, microprocessors, microcontrollers, field programmable gate arrays (FPGAs), application-specified integrated circuits (ASICs), or the like.

Device 700 also includes a power system 742 for powering the various hardware components. Power system 742 can include a power management system, one or more power sources including a battery, an alternating current (AC) circuit, a recharging system, a power failure detection circuit, a power converter or inverter, a power status indicator (e.g., a light emitting diode (LED) and any other components typically associated with the generation, management and distribution of power in mobile devices.

In some embodiments, device 700 includes a charging system 755 that can include a wireless power receiving coil that wirelessly receives power from a charging station (e.g., charging station 200 in FIGS. 2, 3 and 4) that has a wireless power transmitting coil. The received power can be used to charge the battery of device 700 and/or to operate circuitry. In various embodiments charging system 755 can also operate as a communication system that can perform in-band bi-directional communications with a wireless power transfer coil of charging station 200 using modulation of the wireless power transfer signal.

In some embodiments, device 700 includes a camera 744. In some embodiments, device 700 includes sensors 746. Sensors can include accelerometers, compass, gyrometer, pressure sensors, audio sensors, light sensors, barometers, and the like. Sensors 746 can be used to sense location aspects, such as auditory or light signatures of a location.

In some embodiments, device 700 can include a GPS receiver, sometimes referred to as a GPS unit 748. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 718 run various software components stored in medium 702 to perform various functions for device 700. In some embodiments, the software components include an operating system 722, a communication module 724 (or set of instructions), a location module 726 (or set of instructions) and other application programs 734 (or set of instructions).

Operating system 722 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 724 facilitates communication with other devices over one or more external ports 736 or via wireless circuitry 708 and includes various software components for handling data received from wireless circuitry 708 and/or external port 736. External port 736 (e.g., universal serial bus (USB), FireWire, Lightning connector, 60-pin connector, etc.) is adapted for coupling directly to other devices or indirectly over a network (e.g., the Internet, wireless local area network (LAN), etc.).

Location/motion module 726 can assist in determining the current position (e.g., coordinates or other geographic location identifiers) and motion of device 700. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 726 receives data from GPS unit 748 and analyzes the signals to determine the current position of the mobile device. In some embodiments, location/motion module 726 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 708 and is passed to location/motion module 726. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 700 based on the position coordinates of the corresponding transmitters. Regardless of the specific location technology used, location/motion module 726 receives information from which a location fix can be derived, interprets that information, and returns location information, such as geographic coordinates, latitude/longitude, or other location fix data

The one or more applications 734 on device 700 can include any applications installed on the device 700, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 706 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 706 can include a display and user input devices such as a keyboard, mouse, and/or trackpad. In some embodiments, I/O subsystem 706 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 706 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, physical control devices may also include a touch screen and/or a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

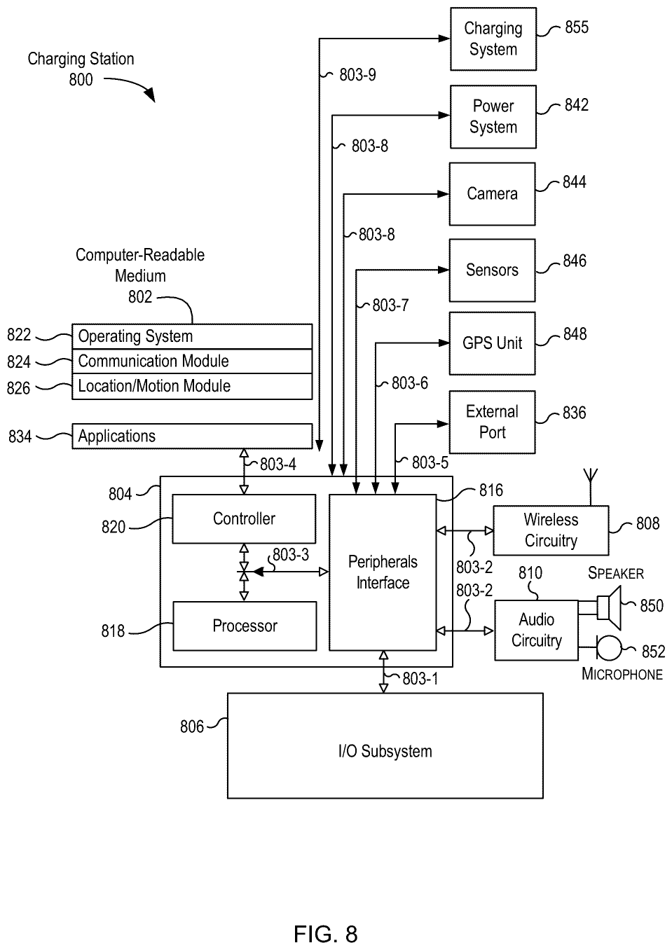

FIG. 8 is a block diagram of an example charging station 800 according to an embodiment. In some embodiments charging station 800 represents charging station 200 as discussed above with reference to FIG. 2 and may include a wireless power transfer coil configured to charge a portable electronic device (e.g., portable electronic device 100 in FIGS. 1, 3 and 4) that is enclosed within a container (e.g., container 105 in FIGS. 1, 3 and 4). In various embodiments charging station 800 include features of charging station 600 as discussed above with reference to FIG. 6, and may include more than one wireless power transfer coil.

Station 800 generally includes computer-readable medium 802, a processing system 804, an Input/Output (I/O) subsystem 806, wireless circuitry 808, and audio circuitry 810 including speaker 812 and microphone 814. These components may be coupled by one or more communication buses or signal lines 803. Station 800 can include a charging apparatus (see e.g., charging station 200 shown in FIGS. 2 and 4; charging station 600 shown in FIG. 6) including at least one charging surface that performs wireless charging of a portable electronic device within a container. Station 800 may include or may be coupled to a computing device that may be for example, a desktop computer, a laptop computer, a tablet computer or a mobile phone. In some embodiments the computing device may be coupled to a cloud server system (e.g., server system/cloud 410 in FIG. 4).

It should be apparent that the architecture shown in FIG. 8 is only one example of an architecture for station 800, and that station 800 can have more or fewer components than shown, or a different configuration of components. The various components shown in FIG. 8 can be implemented in hardware, software, or a combination of both hardware and software, including one or more signal processing and/or application specific integrated circuits.

Wireless circuitry 808 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 808 can use various protocols, e.g., as described herein. In various embodiments, wireless circuitry 808 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 808 is coupled to processing system 804 via peripherals interface 816. Peripherals interface 816 can include conventional components for establishing and maintaining communication between peripherals and processing system 804. Voice and data information received by wireless circuitry 808 (e.g., in speech recognition or voice command applications) is sent to one or more processors 818 via peripherals interface 816. One or more processors 818 are configurable to process various data formats for one or more application programs 834 stored on medium 802.

Peripherals interface 816 couple the input and output peripherals of station 800 to the one or more processors 818 and computer-readable medium 802. One or more processors 818 communicate with computer-readable medium 802 via a controller 820. Computer-readable medium 802 can be any device or medium that can store code and/or data for use by one or more processors 818. Computer-readable medium 802 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 816, one or more processors 818, and controller 820 can be implemented on a single chip, such as processing system 804. In some other embodiments, they can be implemented on separate chips.

Processor(s) 818 can include hardware and/or software elements that perform one or more processing functions, such as mathematical operations, logical operations, data manipulation operations, data transfer operations, controlling the reception of user input, controlling output of information to users, or the like. Processor(s) 818 can be embodied as one or more hardware processors, microprocessors, microcontrollers, field programmable gate arrays (FPGAs), application-specified integrated circuits (ASICs), or the like.

Station 800 also includes a power system 842 for powering the various hardware components. Power system 842 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

Station 800 also includes a charging system 855 that can be used to charge a portable electronic device (e.g., portable electronic device 100 in FIGS. 1, 3 and 4) via wireless charging. Charging system 855 may include one or more wireless power transfer coils and may be configured to wirelessly charge the portable electronic device while it is within a container, such as a retail box. More specifically, in some embodiments charging system 855 may receive power from power system 842 and may be configured to inductively charge portable electronic device 100 while it is within container 105 (FIG. 1) via inductively coupled coils. In various embodiments charging system 855 can also operate as a communication system that can perform in-band bi-directional communications with the wireless power receiving coil of portable electronic device 100 using modulation of the wireless power transfer signal.

In some embodiments, station 800 includes a camera 844 that may be able to detect a portable electronic device placed on a charging surface of the charging station. In some embodiments, station 800 includes sensors 846. Sensors can include accelerometers, compass, gyrometer, pressure sensors, audio sensors, light sensors, barometers, proximity sensors and the like. Sensors 846 can be used to sense location aspects, such as auditory or light signatures of a location and may be able to detect a portable electronic device placed on a charging surface of the charging station.

In some embodiments, station 800 can include a GPS receiver, sometimes referred to as a GPS unit 848. Station 800 can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the station. Based on these estimations, the station can determine a location fix, altitude, and/or current speed. A location fix can be geographical coordinates such as latitudinal and longitudinal information.

One or more processors 818 run various software components stored in medium 802 to perform various functions for station 800. In some embodiments, the software components include an operating system 822, a communication module 824 (or set of instructions) and/or a location module 826 (or set of instructions).

Operating system 822 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 824 facilitates communication with other devices over one or more external ports 836 or via wireless circuitry 808 and includes various software components for handling data received from wireless circuitry 808 and/or external port 836. External port 836 (e.g., universal serial bus (USB), FireWire, Lightning connector, 60-pin connector, etc.) is adapted for coupling directly to other devices or indirectly over a network (e.g., the Internet, wireless local area network (LAN), etc.).

Location/motion module 826 can assist in determining the current position (e.g., coordinates or other geographic location identifiers) and motion of station 800. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 826 receives data from GPS unit 848 and analyzes the signals to determine the current position of the mobile device. In some embodiments, location/motion module 826 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 808 and is passed to location/motion module 826. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for station 800 based on the position coordinates of the corresponding transmitters. Regardless of the specific location technology used, location/motion module 826 receives information from which a location fix can be derived, interprets that information, and returns location information, such as geographic coordinates, latitude/longitude, or other location fix data

In some embodiments wireless circuitry 808 may be used to communicate with a portable electronic device while it is being charged by the charging system 855 of charging station 800. The charging station can receive data from the portable electronic device such as a state of charge of the battery of the portable electronic device, whether the portable electronic device is within a container, a temperature of the portable electronic device or other pertinent information.

The one or more applications 834 on station 800 can include any applications installed on the station 800, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc. In some embodiments station 800 can include a user interface that indicates a status of a wireless charging process and/or a status of a software update of one or more portable electronic devices that are coupled to the charging station (e.g., portable electronic device 100 coupled to charging station 200 as described in FIGS. 3 and 4). In various embodiments station 800 can include an application that communicates the status of the charging and/or software updates to a separate mobile computing device.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 806 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 806 can include a display and user input devices such as a keyboard, mouse, and/or trackpad. In some embodiments, I/O subsystem 706 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 802) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 806 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, station 800 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. Further, any of the software components or functions described in this application may be implemented as software code in a compiled format (e.g., machine language binary code that is processor-executable). The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs comprised of software code and incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the software code may be packaged with a compatible device or provided separately from other devices. In addition, software code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology involves the communication of device information, such as battery states of charge, software versioning, and device type information, between an electronic device that is in-box, and a charging and/or software update station. Although the present technology is particularly useful in the pre-sale context, meaning that the device (e.g., electronic device 100) does not yet contain customer information, implementors are reminded that to the extent personal information data is transmitted, that such transmission occurs after obtaining the user's approval. Entities responsible for the collection, analysis, disclosure, transfer, storage, or other use of such personal information data must comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. Modifications and changes may be made without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A wireless power transmitting device comprising:
a surface adapted to support a container containing a wireless power receiving device;
a wireless power transfer coil positioned to couple with a wireless power receiving coil of the wireless power receiving device when the container is placed on the surface;
a memory comprising computer-executable instructions; and
one or more processors in communication with the memory and configured to access the memory and execute the computer-executable instructions to perform operations comprising:
detect a presence of the wireless power receiving device when the container containing the wireless power receiving device is placed on the surface;
determining whether the wireless power receiving device permits wireless power transfer while it is inside the container; and
using the wireless power transfer coil, wirelessly transmit power to the wireless power receiving device through the container to charge a battery of the wireless power receiving device, in accordance with determining the wireless power receiving device permits wireless power transfer while it is inside the container.

2. The wireless power transmitting device of claim 1, wherein determining whether the wireless power receiving device permits wireless power transfer while it is inside the container comprises: communicating with the wireless power receiving device using modulation of a wireless power transfer signal at the wireless power transfer coil.

3. The wireless power transmitting device of claim 1, wherein determining whether the wireless power receiving device permits wireless power transfer while it is inside the container comprises: communicating with the wireless power receiving device using a wireless communication protocol and circuitry other than the wireless power transfer coil.

4. The wireless power transmitting device of claim 3, wherein the wireless communication protocol and circuitry are near-field communications (NFC).

5. The wireless power transmitting device of claim 3, wherein the wireless communication protocol and circuitry are Bluetooth, WiFi, or RFID.

6. The wireless power transmitting device of claim 1, wherein the operations further comprise, in response to determining that the battery of the wireless power receiving device has been charged to a threshold level, transmitting instructions to the wireless power receiving device to update an operating system.

7. The wireless power transmitting device of claim 6, wherein transmitting instructions to the wireless power receiving device to update an operating system comprises determining an existing version of operating system installed on the wireless power receiving device and determining that a version of the operating system newer than the existing version is available.

8. The wireless power transmitting device of claim 1, wherein the operations further comprise, in response to determining that the wireless power receiving device has been registered with a user account or registered with a SIM credential (either physical or e-SIM), determining that the wireless power receiving device has been removed from the container.

9. The wireless power transmitting device of claim 1, wherein the operations further comprise determining whether a temperature of the wireless power receiving device exceeds an inbox charging threshold and discontinuing the transmitting the power signal responsive to determining the temperature exceeds the inbox charging threshold.

10. The wireless power transmitting device of claim 1, wherein the wireless power transmitting device further comprises a plurality of wireless power transfer coils and wherein detecting a presence of the wireless power receiving device when the container containing the wireless power receiving device is placed on the surface comprises detecting coupling between a particular wireless power transfer coil of the plurality of wireless power transfer coils of the wireless power transmitting device with the wireless power receiving coil of the wireless power receiving device;
selecting the particular wireless power transfer coil of the plurality of wireless power transfer coils; and
using the selected wireless power transmit coil to wirelessly transmit power to the wireless power receiving device.

11. The wireless power transmitting device of claim 1, wherein the wireless power transmitting device further comprises a ferrite material abutting the wireless power transfer coil; and
wherein the ferrite material is shaped to optimize transmission of flux generated by the wireless power transfer coil, through a wall of the container, towards the wireless power receiving coil of the wireless power receiving device.

12. A portable electronic device comprising:
a memory comprising computer-executable instructions; and one or more processors in communication with the memory and configured to access the memory and execute the computer-executable instructions to perform operations comprising:
detecting a wireless communication signal;
in response to detecting the wireless communication signal, determining whether the portable electronic device is enclosed within a container; and
in response to determining that the portable electronic device is enclosed within the container, wirelessly receiving power to charge a battery of the portable electronic device.

13. The portable electronic device of claim 12, wherein the operations further comprise wirelessly receiving data through the container and in response to receiving the data, updating an operating system of the portable electronic device.

14. The portable electronic device of claim 13, wherein the wireless communication signal is received by a first antenna and wherein the data is received by a second antenna.

15. The portable electronic device of claim 12, wherein the container comprises a non-electrically conductive wall and wherein the portable electronic device is positioned adjacent the non-electrically conductive wall.

16. The portable electronic device of claim 12, wherein the operations further comprise, in response to detecting the wireless communication signal, determining whether the portable electronic device is unregistered with a user account or is not registered with SIM; and
in response to determining that the electronic device is unregistered or is not registered with a SIM, establish communications with a wireless power transmitter via a wireless power receiving coil.

17. The portable electronic device of claim 12, wherein the operations further comprise, in response to detecting the wireless communication signal, transitioning from a power save mode to an active mode.

18. The portable electronic device of claim 12, wherein the operations further comprise, in response to detecting the wireless communication signal, determining whether the wireless communication signal is from a charger configured to perform in-box charging of the portable electronic device; and
in response to determining that the wireless communication signal is from a charger configured to perform in-box charging of the portable electronic device, wirelessly receiving the power to charge the battery of the portable electronic device.

19. The portable electronic device of claim 18, wherein the operations further comprise, in response to detecting the wireless communication signal, turning on at least one of an NFC, Bluetooth, WiFi or RFID communications circuit, in accordance with determining that the wireless communication signal is from a charger configured to perform in-box charging of the portable electronic device.

20. The portable electronic device of claim 18, wherein the operations further comprise, communicating with the charger to transmit at least one of a battery state-of-charge, an operating system version or a thermal status, in accordance with determining that the wireless communication signal is from a charger configured to perform in-box charging of the portable electronic device.
